(19) United States
(12) Patent Application Publication
(10) Pub. No.: US 2006/0242104 A1
(43) Pub. Date: Oct. 26, 2006

(54) Systems and methods for manipulating data in a data storage system

(75) Inventors: Nigel R. Ellis, Redmond, WA (US); Gregory S. Friedman, Redmond, WA (US); Jason T. Hunter, Redmond, WA (US); Richard L. Negrin, Mercer Island, WA (US); Michael J. Newman, Redmond, WA (US); Jeffrey T. Pearce, Sammamish, WA (US); Jack Richins, Bothell, WA (US); Amit Shukla, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/111,557

(22) Filed: Apr. 21, 2005

(51) Int. Cl. G06F 17/30

(52) U.S. Cl. 707/1; 707/8

(57) ABSTRACT

The subject invention provides a system and/or a method that facilitates manipulating data associated to a data storage system, wherein the data storage system has at least one of a characteristic and a constraint associated to a data model. The data model can represent the data storage system such that the data storage system is a database-based file system. A data manipulation component can manipulate data associated to the data model and enforces at least one of the constraint and the characteristic to ensure integrity of such system. In addition, an API component can be invoked to provide the manipulation of data within the data storage system.

### TECHNICAL FIELD

The present invention generally relates to databases, and more particularly to systems and/or methods that facilitate manipulating data based on a data model and/or security implementation associated with a respective data storage system.

### BACKGROUND OF THE INVENTION

Advances in computer technology (e.g., microprocessor speed, memory capacity, data transfer bandwidth, software functionality, and the like) have generally contributed to increased computer application in various industries. Ever more powerful server systems, which are often configured as an array of servers, are commonly provided to service requests originating from external sources such as the World Wide Web, for example.

As the amount of available electronic data grows, it becomes more important to store such data in a manageable manner that facilitates user friendly and quick data searches and retrieval. Today, a common approach is to store electronic data in one or more databases. In general, a typical database can be referred to as an organized collection of information with data structured such that a computer program can quickly search and select desired pieces of data, for example. Commonly, data within a database is organized via one or more tables. Such tables are arranged as an array of rows and columns.

Also, the tables can comprise a set of records, wherein a record includes a set of fields. Records are commonly indexed as rows within a table and the record fields are typically indexed as columns, such that a row/column pair of indices can reference particular datum within a table. For example, a row can store a complete data record relating to a sales transaction, a person, or a project. Likewise, columns of the table can define discrete portions of the rows that have the same general data format, wherein the columns can define fields of the records.

Each individual piece of data, standing alone, is generally not very informative. Database applications make data more useful because they help users organize and process the data. Database applications allow the user to compare, sort, order, merge, separate and interconnect the data, so that useful information can be generated from the data. Capacity and versatility of databases have grown incredibly to allow virtually endless storage capacity utilizing databases. However, typical database systems offer limited query-ability based upon time, file extension, location, and size. For example, in order to search the vast amounts of data associated to a database, a typical search is limited to a file name, a file size, a date of creation, etc., wherein such techniques are deficient and inept.

With a continuing and increasing creation of data from end-users, the problems and difficulties surrounding finding, relating, manipulating, and storing such data escalate. End-users write documents, store photos, rip music from compact discs, receive email, retain copies of sent email, etc. For example, in the simple process of creating a music compact disc, the end-user can create megabytes of data. Ripping the music from the compact disc, converting the file to a suitable format, creating a jewel case cover, and designing a compact disc label, all require the creation of data.

Not only are the complications surrounding users, but developers have similar issues with data. Developers create and write a myriad of applications varying from personal applications to highly developed enterprise applications. While creating and/or developing, developers frequently, if not always, gather data. When obtaining such data, the data needs to be stored. In other words, the problems and difficulties surrounding finding, relating, manipulating, and storing data affect both the developer and the end user. In particular, the integrity of data must be ensured with any manipulation of such data without disrupting and/or invoking any unstable conditions within conventional systems and/or databases.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The subject invention relates to systems and/or methods that facilitate manipulating data based at least in part upon a data model associated with characteristics and/or constraints. A data model can represent a data storage system (e.g., a database-based file storage system), wherein such model is a hierarchical model of persisted entities and sub-entities that can represent information within a data storage system as instances of complex types. In order to facilitate manipulating data, a data manipulation component can provide data manipulation procedures associated with the data storage system while enforcing and/or implementing at least one of a characteristic and/or constraint. In other words, the data manipulation component persists data within the data storage system during any suitable data manipulation.

In accordance with one aspect of the subject invention, the data manipulation component can include a procedure component that provides at least one procedure, wherein the procedure manipulates data. The procedure on data may implement a copy, an update, a replace, a get, a set, a create, a delete, a move, a modify, etc. Moreover, the data manipulation component can include an enforcer component that enforces and/or implements a characteristic and/or constraint associated with the data model that represents a data storage system. By utilizing a characteristic and/or constraint in association with the data manipulation, the integrity of the data model is maintained throughout the data storage system.

In accordance with another aspect of the subject invention, the data manipulation component can utilize an application programming interface (API). The API can be exposed to clients (e.g., a caller), wherein the API is a public surface area that can call one or more private implementation routines to carry out a client request. In one aspect, the API can provide the routines (e.g., no subroutines can be involved). The API can be utilized to allow a user to call and/or utilize at least one procedure associated with manipulating data within the data storage system while maintaining at least one characteristic and/or constraint associated therewith. The API can further utilize an API definition component that can define various functions and/or procedures allowing suitable operations to be performed within the data storage system.

In accordance with still another aspect, the data manipulation component can include a locking component that facilitates supporting multiple concurrent callers, while at the same time eliminating deadlocks. For instance, imagine a scenario where there are multiple concurrent callers who request ownership of a common set of resources in such a way that none of the requests can be satisfied because each caller is waiting on the other, thus a deadlock can occur. In such a case, the locking component can lock up (e.g., the callers are blocked), wherein the only way out of such case is to evict one of the callers. The locking component can also support multiple concurrent callers such that a complex locking logic can guarantee individual requests to either succeed or fail atomically. Furthermore, the data manipulation component can include an optimistic concurrency component that utilizes an optimistic concurrency technique, wherein such technique assumes that the likelihood of a first process making a change at the substantially similar time as a second process is low and a lock is not employed until the change is committed to the data storage system. Where a concurrent access by multiple callers causes a particular caller's assumptions about a state of the store to be invalid, the invalid assumptions can be detected and data change requests are rejected by the system until the caller re-synchronizes the understanding of the system state and re-submits the request. This technique can improve the performance of the system by eliminating the necessity of executing the instructions to take out a lock. Furthermore, this technique can reduce deadlocks in the system, by eliminating the need to take out long term locks

In accordance with another aspect of the subject invention, the data manipulation component can include a security component that provides security techniques that can correspond to the various data manipulations employed by such system. The security component can utilize a user profile and/or various security measures such as, but not limited to, a login, a password, biometric indicia (e.g., a fingerprint, a retinal scan, inductance, . . . ), voice recognition, etc. to ensure the integrity and validity of the particular entity manipulating data. Furthermore, the data manipulation component can include an error component that provides an error code in the event that the data manipulation will entail a characteristic and/or constraint to not be enforced. The error code can be implemented to signify that the data manipulation is incomplete, wherein the error code can correspond to text describing an error. In other aspects of the subject invention, methods are provided that facilitate manipulating data while conforming to a data model.

The following description and the annexed drawings set forth in detail certain illustrative aspects of the invention. These aspects are indicative, however, of but a few of the various ways in which the principles of the invention may be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a block diagram of an exemplary system that facilitates manipulating data based at least in part upon a data model with respective characteristics.

FIG. 2 illustrates a block diagram of an exemplary system that facilitates manipulating data within the characteristics of a data storage system.

FIG. 3 illustrates a block diagram of an exemplary system that facilitates implementing data integrity and security with the manipulation of data associated with a data storage system.

FIG. 4 illustrates a block diagram of an exemplary system that facilitates implementing an API that manipulates data associated with a data storage system.

FIG. 5 illustrates a block diagram of an exemplary system that facilitates invoking an API that manipulates data within the characteristics of a data storage system.

FIG. 6 illustrates a block diagram of an exemplary system that facilitates invoking an API that manipulates data within the characteristics of a data storage system.

FIG. 7 illustrates a block diagram of an exemplary system that facilitates manipulating data within a data storage system utilizing an API component.

FIG. 8 illustrates a block diagram of an exemplary system that facilitates manipulating data based at least in part upon a data model.

FIG. 9 illustrates an exemplary methodology for invoking a data manipulation based at least in part upon a database-based system while enforcing at least one model constraint.

FIG. 10 illustrates an exemplary methodology for manipulating data based at least upon a data model with respective characteristics being enforced.

FIG. 11 illustrates an exemplary networking environment, wherein the novel aspects of the subject invention can be employed.

FIG. 12 illustrates an exemplary operating environment that can be employed in accordance with the subject invention.

### DESCRIPTION OF THE INVENTION

As utilized in this application, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The subject invention is described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

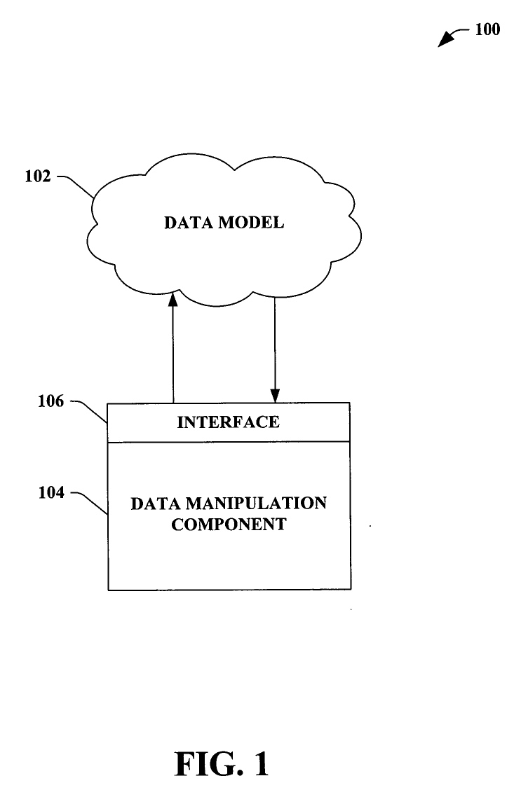

Now turning to the figures, FIG. 1 illustrates a system 100 that facilitates manipulating data based at least upon a data model with a characteristic respective thereof. A data model 102 can be a complex model based at least upon a database structure, wherein an item, a sub-item, a property, and a relationship are defined to allow representation of information within a data storage system as instances of complex types. The data model 102 can utilize a set of basic building blocks for creating and managing rich, persisted objects and links between objects. An item can be defined as the smallest unit of consistency within the data model 102, which can be independently secured, serialized, synchronized, copied, backup/restored, etc. The item is an instance of a type, wherein all items in the data model 102 can be stored in a single global extent of items. The data model 102 can be based upon at least one item and/or a container structure. Moreover, the data model 102 can be a storage platform exposing rich metadata that is buried in files as items. It is to be appreciated that the data model 102 can represent a database-based file storage system to support the above discussed functionality, wherein any suitable characteristics and/or attributes can be implemented. Furthermore, the data model 102 can represent a database-based file storage system that utilizes a container hierarchical structure, wherein a container is an item that can contain zero or more items. The containment concept is implemented via a container ID property inside the associated class. A store can also be a container such that the store can be a physical organizational and manageability unit. In addition, the store represents a root container for a tree of containers within the hierarchical structure. Moreover, the data model 102 can represent a data storage system that is a database-based system that defines a hierarchical model of at least one persisted entity and zero or more sub-entities per each entity to represent information as a complex type.

A data manipulation component 104 can manipulate data related to the data model 102 while ensuring data integrity and stability associated with characteristics of such data model 102. The data model 102 can include any suitable characteristics and/or guidelines associated with the database-based file storage system. The data manipulation component 104 can provide a move, a delete, a copy, a create, an update, a replace, etc. to at least one object while ensuring a stable system (e.g., conforming to any characteristics associated to the database-based file storage system represented by the data model 102). For example, a data model 102 can represent a database-based file storage system that has the characteristic where each ID for a container is unique. Continuing with the example, the data manipulation component 104 can employ any suitable data manipulation (e.g., copy, update, replace, get, set, create, delete, move, . . . ) while enforcing and/or upholding the uniqueness of the ID for the containers. It is to be appreciated that the functions depicted above are not to be seen as limiting on the subject invention and that any suitable data manipulation involving the data model 102 can be employed while sustaining any suitable characteristic relating therewith. Moreover, it is to be understood that the data manipulation component 104 can manipulate data corresponding to the hierarchical structure (e.g., utilizing at least one of a store and a container, . . . ) based upon the data model 102.

In accordance with one aspect of the subject invention, the manipulation of data can be based at least in part upon an input from a user by utilizing, for instance, an application programming interface (API) (not shown). By employing the API, the interactions and/or manipulations involving the data model 102 and corresponding database-based file storage system can be implemented while sustaining/enforcing any suitable characteristic associated therewith. It is to be appreciated and understood that the API can be invoked by the data manipulation component 104, a separate component, incorporated into the data manipulation component 104, and/or any combination thereof.

The system 100 further includes an interface component 106, which provides various adapters, connectors, channels, communication paths, etc. to integrate the data manipulation component 104 into virtually any operating and/or database system(s). In addition, the interface component 106 can provide various adapters, connectors, channels, communication paths, etc. that provide for interaction with data and the data manipulation component 104. It is to be appreciated that although the interface component 106 is incorporated into the data manipulation component 104, such implementation is not so limited. For instance, the interface component 106 can be a stand-alone component to receive or transmit the data in relation to the system 100.

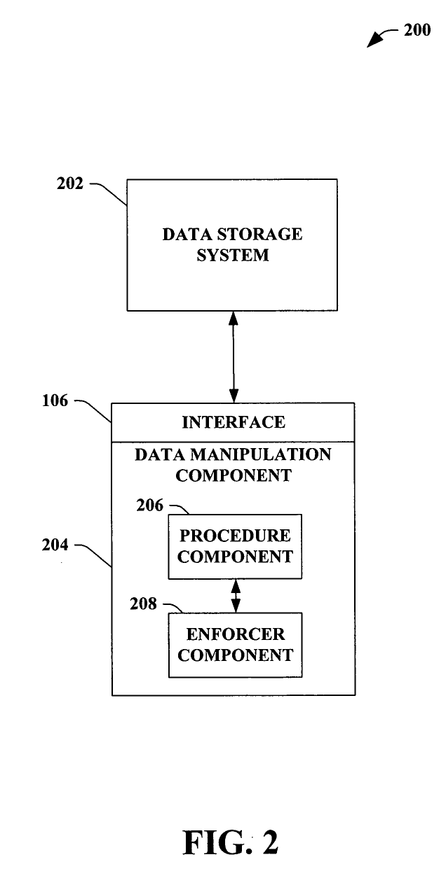

FIG. 2 illustrates a system 200 that facilitates manipulating data within the characteristics of a data storage system. A data storage system 202 can be a database-based file storage system that represents instances of data as complex types by utilizing at least a hierarchical structure. The data storage system 202 can include at least one characteristic that is enforced to ensure the data storage system 202 characteristics while data is manipulated. It is to be appreciated that a data model (not shown) can represent the data storage system 202. Moreover, an item, a sub-item, a property, and a relationship can be defined within the data storage system 202 to allow the representation of information as instances of complex types. The data storage system 202 can be a data model that can describe a shape of data, declare constraints to imply certain semantic consistency on the data, and define semantic associations between the data. The data storage system 202 can utilize a set of basic building blocks for creating and managing rich, persisted objects and links between objects.

For instance, the building blocks can include an “Item,” an “ItemExtension,” a “Link,” and an ItemFragment.” An “Item” can be defined as the smallest unit of consistency within the data storage system 202, which can be independently secured, serialized, synchronized, copied, backup/restored, etc. For instance, items can be the smallest unit of consistency, but the boundary drawn around an item can include links, item extensions, and item fragments that can be logically owned by the item. Thus, an item can be a row in a table, but also refer to the item row and all of its secondary parts. In other words, the item can be deleted, copied, etc. with a guarantee that such operation is atomically applied to the item and all of its parts. The item is an instance of a type, wherein all items in the data storage system 202 can be stored in a single global extent of items. An “ItemExtension” is an item type that is extended utilizing an entity extension. The entity extension can be defined in a schema with respective attributes (e.g., a name, an extended item type, a property declaration, . . . ). The “ItemExtension” can be implemented to group a set of properties that can be applied to the item type that is extended. A “Link” is an entity type that defines an association between two item instances, wherein the links are directed (e.g., one item is a source of the link and the other is the target of the link). An “ItemFragment” is an entity type that enables declaration of large collections in item types and/or item extensions, wherein the elements of the collection can be an entity. It is to be appreciated and understood that the data storage system 202 can represent any suitable database-based file storage system that provides the representation of data as instances of complex types and the above depiction is not to be seen as limiting the subject invention. The data storage system 202 can be substantially similar to the representation of the data model 102 depicted in FIG. 1.

A data manipulation component 204 can provide the manipulation of data within the data storage system 202 while enforcing at least one characteristic associated to such data storage system 202. The data manipulation component 204 can provide a manipulation such as, but not limited to, a copy, an update, a replace, a get, a set, a create, a delete, a move, etc. on data (e.g., represented by instances of complex types). It is to be appreciated that the data manipulation component 204 can be substantially similar to the data manipulation component 104 as depicted in FIG. 1.

The data manipulation component 204 can include a procedure component 206 that provides specific functions to manipulate data in accordance to characteristics associated with the data storage system 202. In other words, the procedure component 206 can provide manipulation techniques related to the data storage system 202. For instance, the procedure component 206 can include a copy, a move, a replace, a set, a delete, a create, a get, an update, on data and/or the representation of data as instances of complex types. It is to be appreciated that the procedure component 206 can provide any suitable data manipulation technique and/or function that can be implemented with the data storage system 202. Although the procedure component 206 is depicted as being incorporated into the data manipulation component 204, the subject invention is not so limited. The procedure component 206 can also be a stand-alone component or incorporated into the data storage system 202 (e.g., which can be an instantiation of a data model concept).

The data manipulation component 204 can further include an enforcer component 208 to incorporate at least one characteristic of the data storage system 202 with the manipulation of data. As discussed above, the data storage system 202 can include any suitable number of characteristics that can provide guidance on the manipulation of data within such data storage system 202. In other words, the enforcer component 208 allows the manipulation of data within the data storage system 202 without disturbing the data model constraints related to the data storage system 202. It is to be appreciated that the enforcer component 208 can be incorporated into the data manipulation component 204 (as shown), a stand-alone component, incorporated into the data storage system 202, and any combination thereof.

For example, the data storage system 202 can utilize an item, a container and a store structure hierarchy (as discussed above). The enforcer component 208 can implement characteristics relating to a container ID associated to the data storage system 202. For instance, the enforcer component 208 can provide at least one of the following: (1) the container ID to contain a non-null item ID of an item in the store (e.g., this can be implemented with the manipulation functions and/or techniques “CreateItem,” “CreateComplexItems,” “MoveItem,” and “ReplaceItem” discussed infra); (2) the container ID is not updated utilizing the manipulation function and/or technique “UpdateItem” (discussed infra); and (3) the container ID can be changed via a call to “MoveItem.” It is to be appreciated and understood the subject invention is not so limited to the reference names of the above functions and/or techniques.

In another example, the enforcer component 208 can implement a transaction semantic in conjunction with the manipulation of data. The enforcer component 208 can implement the following transaction semantics: (1) if no transaction is active, an error code can be returned and a batch is not processed; and (2) an attempt is made to validate and apply the operation. If validating and applying the operation succeeds, control can be returned to the caller with the effects of the operation uncommitted in the transaction supplied by the caller. If validating or applying the operation failed, the transaction fails and an error is raised, and control can be returned to the caller. A failed transaction means the caller can issue queries on that transaction but cannot commit the transaction (e.g., a call to commit can result in an error). It is to be appreciated that the API request can either succeed atomically or fail completely. A complex API can make at least one change to an underlying storage table and can implement a complex set of consistency and/or integrity tests. Moreover, it is to be appreciated that the system 200 will never be left in an inconsistent and/or invalid state.

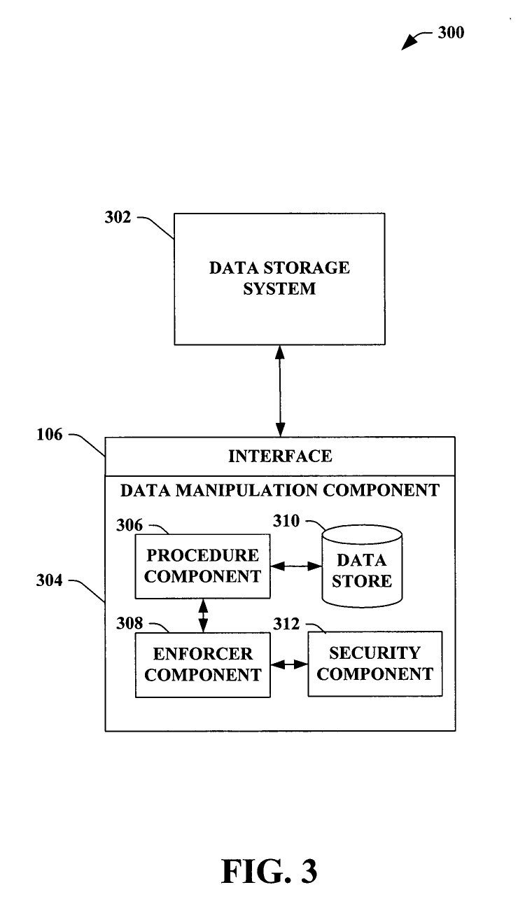

FIG. 3 illustrates a system 300 that facilitates implementing data integrity and security with the manipulation of data associated with a data storage system. A data storage system 302 can be a database-based file storage system based at least in part upon a data model, wherein data is represented as instances of complex types. A data manipulation component 304 can provide data manipulation associated to the data storage system 302. The data manipulation component 304 can include a procedure component 306 that can provide at least one function and/or technique involved with manipulating data within the data storage system 302. Furthermore, the data manipulation component 304 can include an enforcer component 308 that institutes at least one characteristic and/or guideline respective the data storage system 302, wherein such characteristic ensures a data model constraint to be implemented with the manipulation of data. It is to be appreciated and understood that the data storage system 302, the data manipulation component 304, the procedure component 306, and the enforcer component 308 can be substantially similar to the data storage system 202, the data manipulation component 204, the procedure component 206, and the enforcer component 308 respectively in FIG. 3.

The data manipulation component 304 can include a data store 310 to facilitate storing and/or accessing at least one procedure associated with manipulating data within the data storage system 302. For example, the data store 310 can store a procedure (e.g., code) that can be utilized by an API, wherein a data manipulation can be received by a user and invoked while maintaining at least one characteristic associated with the data storage system 302. In another example, the data store 310 can store various characteristics associated with the data storage system 302 and/or various API data (e.g., sub-routines, etc.) In one example, the data store 310 can be a hard drive. The data store 310 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 310 of the subject systems and methods is intended to comprise, without being limited to, these and any other suitable types of memory. In addition, it is to be appreciated that the data store 310 can be a server and/or database.

The data manipulation component 304 can further include a security component 312 to provide at least one security attribute to the system 300. For instance, the security component 304 can utilize a user profile such that particular data manipulation functions and/or techniques are associated therewith. Furthermore, the security component 304 can utilize various security measures such as, but not limited to, a login, a password, biometric indicia (e.g., a fingerprint, a retinal scan, inductance, . . . ), voice recognition, etc. to ensure the integrity and validity of the particular entity manipulating data. The security component 312 can further employ any suitable security attribute associated to the data storage system 302. In other words, the security component 312 can implement security regulations such that the data storage system 302 security constraints are enforced.

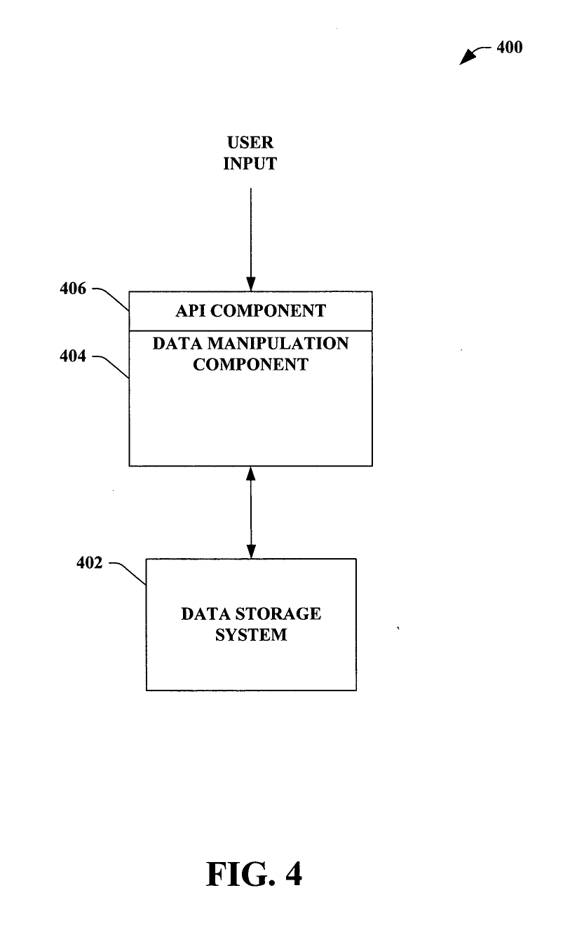

FIG. 4 illustrates a system 400 that facilitates implementing an API that manipulates data associated with a data storage system. A data storage system 402 can be a database-based file storage system having at least one characteristic associated therewith, wherein the data storage system 402 can be represented by a data model (not shown). A data manipulation component 404 can allow a data manipulation that includes, but is not limited to, a copy, a move, a replace, a set, a delete, a create, a get, an update to data respective to the data storage system 402. It is to be appreciated that the data storage system 402 and the data manipulation component 404 can utilize substantially similar functionality as the data storage system 302, the data storage system 202, the data manipulation component 304, and the data manipulation component 204, in FIGS. 3 and 2 respectively.

The data manipulation component 404 can further include an API component 406 (herein referred to as “API 406”) that allows an entity to manipulate data in the data storage system 402. The entity can be, but is not limited to, a user, a computer, a database, . . . . The API 406 can receive at least a user input such that the user input is a command and/or function involving the manipulation of data within the data storage system 402. Although depicted as being incorporated into the data manipulation component 404, it is to be appreciated that the API 406 can be a stand-alone component, incorporated into the data storage system 402, and/or a combination thereof. Moreover, the API 406 can utilize various components previously discussed to provide the manipulation of data utilizing particular procedures while enforcing characteristics respective to the data storage system 402.

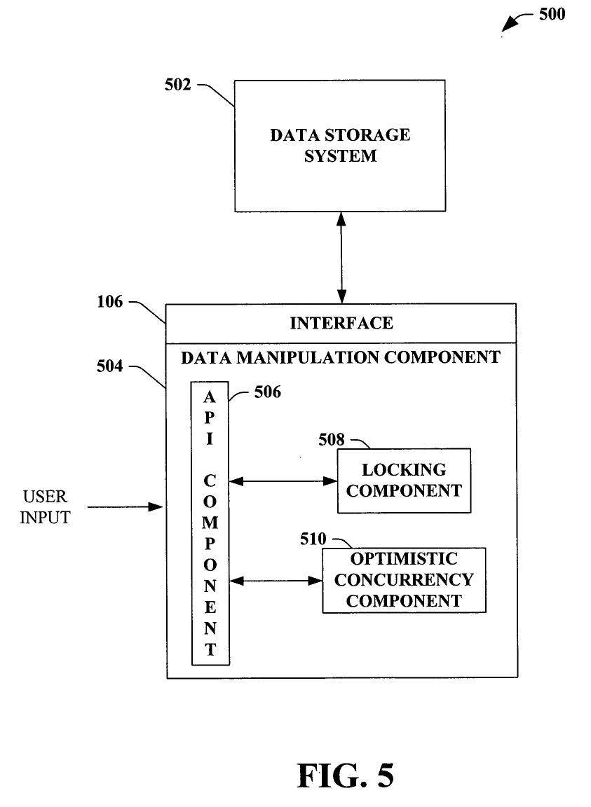

FIG. 5 illustrates a system 500 that facilitates invoking an application programming interface (API) that manipulates data within the characteristics of a data storage system. A data storage system 502 can be a database-based file storage system with at least one defining characteristic, wherein the data storage system 502 can be based at least in part upon a data model (not shown). A data manipulation component 504 can allow a data manipulation that includes, but is not limited to, a copy, a move, a replace, a set, a delete, a create, a get, an update to data respective to the data storage system 502. It is to be appreciated that the data storage system 502 and the data manipulation component 504 can be substantially similar to the data storage system 402, the data storage system 302, the data storage system 202, the data manipulation component 404, the data manipulation component 304, and the data manipulation component 204, in FIG. 4, FIG. 3, and FIG. 2 respectively.

The data manipulation component 504 can include an API component 506 (referred to as “API 506”). The API 506 can provide the data manipulations (e.g., create, update, and deletion of data within a store) by executing the stored procedures. The API 506 can allow, for instance, a user to implement the data manipulation while ensuring the integrity and/or purity of the characteristics associated with the data storage system 502. The manipulation of data can be based at least in part upon an input from a user by utilizing, for instance, the API 506. By employing the API 506, the interactions and/or manipulations involving the data storage system 502 can be implemented while sustaining/enforcing any suitable characteristic associated therewith. It is to be appreciated and understood that the API 506 can be invoked by the data manipulation component 504, a separate component, incorporated into the data manipulation component 504, and/or any combination thereof.

The data manipulation component 504 can further include a locking component 508 that facilitates concurrently accessing data with one or more applications by utilizing appropriate locking strategies which guarantee integrity. For instance, imagine a scenario where there are multiple callers who request ownership of a common set of resources in such a way that no single request can be satisfied because each caller is waiting on the other (e.g., a deadlock can occur). In such a case, the locking component 508 can allow the callers to be blocked (e.g., lock up), wherein the only way out of such case is to evict one of the callers. To avoid this situation, the locking component 508 can support multiple concurrent callers such that a complex locking logic can guarantee individual requests to either succeed or fail automatically. Moreover, the locking component 508 can detect and react to deadlocks. The locking component 508 can keep the data consistent by employing serialized access to certain parts of the data storage system (e.g., a store) via locking. Locking can be done on a granular level, wherein the resources in the data storage system (e.g., the store) that are affected by a given manipulation and/or operation can be locked for the duration of such manipulation and/or operation. It is to be appreciated that different operations and/or the substantially similar operation can take the locks in a different order, deadlocking can occur. For example, the locking component 508 can avoid a deadlock with a significant loss to performance. Furthermore, the locking component 508 can provide the API 506 with a deadlock error code to inform of such situation.

The data manipulation component 504 can include an optimistic concurrency component 510. The API 506 can utilize optimistic concurrency for applying manipulation and/or changes to data within the data storage system 502. Concurrency occurs when at least two processes attempt to update substantially similar data at a substantially similar time. The optimistic concurrency component 510 utilizes optimistic concurrency, wherein the optimistic concurrency assumes the likelihood of another process making a change at the substantially similar time is low, so it does not take a lock until the change is ready to be committed to the data storage system (e.g., store). By employing such technique, the optimistic concurrency component 510 reduces lock time and offers better database performance. Where concurrent access by multiple callers causes a particular caller's assumptions about a state of the store to be invalid, the invalid assumptions can be detected and data change requests are rejected by the system until the caller re-synchronizes the understanding of the system state and re-submits the request

For instance, the optimistic concurrency component 510 can keep a token associated with the item that changes with each modification of the item. The token is passed to the caller when data is read into memory. The caller can pass the token back down to the store as a parameter to an update operation. The store can compare the token passed in with the current token value in the store. If the tokens are equal, then the write will succeed and be implemented. Yet, if the caller's version in memory is a different value then the one in the store, it signifies that the item has been modified by another application and the write will fail.

In another example, a failure due to concurrent access by two applications is examined. In the table below, there are two applications running concurrently on the data storage system 502 that will attempt to modify the item.

| | | Item | |
|---|---|---|---|
| | | token | |
| | | value | |
| Time | Application 1 | In Store | Application 2 |
| 1 | Idle | 1 | idle |
| 2 | Item is fetched into | 1 | idle |
| | memory. | | |
| | Item Token == 1 | | |
| 3 | Idle | 1 | Item is fetched into memory. |
| | | | Item Token == 1 |
| 4 | Idle | 1 | Item is modified in memory. |
| | | | Item Token == 1 |
| 5 | Idle | 1 | Item is committed back to the |
| | | | store. Write succeeds because the |
| | | | token value in memory matches |
| | | | the token value in the store. Now |
| | | | Item Token == 2 |
| 6 | Item is modified in | 2 | idle |
| | memory. | | |
| | Item Token == 1 | | |
| 7 | Item is commited | 2 | idle |
| | back to the store. | | |
| | ERROR! Item | | |
| | Token in memory (a | | |
| | value of 1) does not | | |
| | match store token | | |
| | value (a value of 2). | | |

The API 506 can support this technique by returning token information on each create and/or update operation. For example, the output token parameter from the create functions can be named “concurrencyToken.” The API 506 can also take token information as an input parameter on update and/or delete operations. The token information passed into the update and/or delete operations can also be referred to as “concurrencyToken.” It is to be appreciated that the parameter can be both an input and output parameter. On input, the “concurrencyToken” is the value that is received when the object was read into a cache, created, and/or updated. This can be the “expected value” in the store if there is no write to the object. On output, the store can return the new “concurrencyToken” of the object after the operation is completed successfully.

The “concurrencyToken” parameter can be typed as a BIGINT (e.g., a 64 bit integer). It is to be appreciated that the parameter can be a database timestamp, yet it may not increase in value. Restoring an item from backup can cause a status that is in the past in relation to time. The only supported operation between two “concurrencyTokens” is for equality and/or inequality. This value can also be available in the various views supported by the store. The column name in the views is “LastUpdateLocalTS” for items, item extensions, links, and item fragments. For security descriptors the column name is “SDLastUpdateLocalTS.”

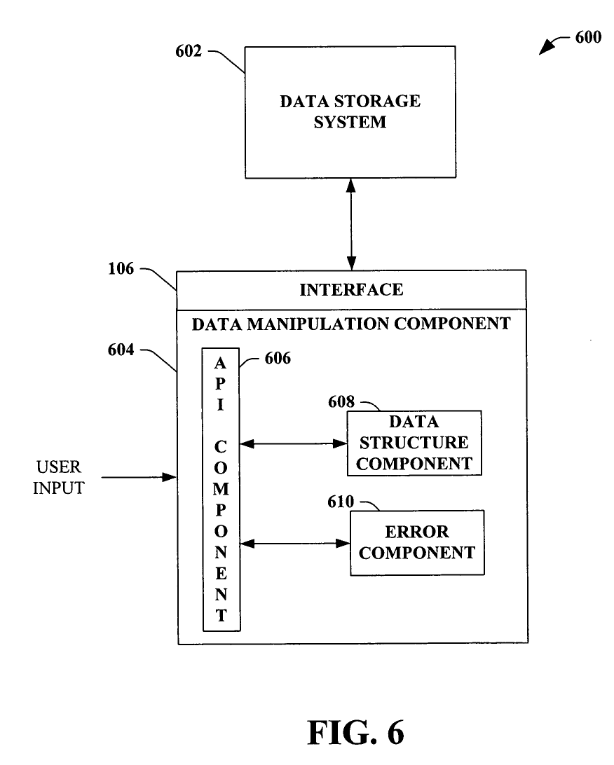

FIG. 6 illustrates a system 600 that facilitates invoking an API that manipulates data within the characteristics of a data storage system. A data storage system 602 can be a database-based file storage system based at least in part upon a data model, wherein data is represented as instances of complex types. A data manipulation component 604 can provide data manipulation associated with the data storage system 602. The data manipulation component 604 can invoke an API component 606 (herein referred to as the “API 606”). The API 606 can provide the data manipulations (e.g., create, update, and deletion of data within a store) by executing the stored procedures. The API 606 can allow, for instance, a user to implement the data manipulation while ensuring the integrity and/or purity of the characteristics associated with the data storage system 602. The data storage system 602, the data manipulation component 604, and the API 606 can be substantially similar to the data storage system 502, 402, 302, and 202, the data manipulation component 504, 404, 304, and 204, the API 506, 406 in FIGS. 5, 4, 3, and 2 respectively.

The data manipulation component 604 can include a data structure component 608 that can employ at least one data structure utilized by the API 606. For instance, the data structure component 608 can utilize various synonyms and/or generic list types. In one example, the following tables can define the synonym and a structured query language (SQL) type, and a list type and a corresponding common language runtime (CLR). It is to be appreciated that the following tables are examples and the subject invention is not so limited.

| Synonym | Sql Type |
|---|---|
| [System.Storage.Store].ItemId | UNIQUEIDENTIFIER |
| [System.Storage.Store].LinkId | UNIQUEIDENTIFIER |
| [System.Storage.Store].TypeId | UNIQUEIDENTIFIER |
| [System.Storage.Store]. | VARBINARY(MAX) |
| CompiledChangeDefinition | |
| [System.Storage.Store].FragmentId | UNIQUEIDENTIFIER |
| [System.Storage.Store].Usage | UNIQUEIDENTIFIER |
| [System.Storage.Store].SecurityDescriptor | VARBINARY(MAX) |

| List Type | Corresponding CLR equivalent |
|---|---|
| [System.Storage.Store]. | SqlList<[System.Storage.Store]. |
| AssignmentValueList | AssignmentValue> |
| [System.Storage.Store]. | SqlList<[System.Storage.Store].ComplexItem> |
| ComplexItemList | |
| [System.Storage.Store]. | SqlList<[System.Storage.Store].ItemId> |
| ItemIdList | |

The data structure component 608 can employ a change definition type. The API 606 and the data manipulation component 604 can provide update operations and/or modifications at the property granularity level. By utilizing such technique, a caller can pass the changed data to the update method while keeping the size of the operation proportional to the size of data changed. The granular updates can be described utilizing the ChangeDefinition type. In the data storage system 602, objects are persisted in a store, wherein a particular cell of a table a stored instance of Contact or some other complex type having properties that could be complex. It is to be appreciated and understood that the ChangeDefinition type can model a set of changes that can be applied to a structured object.

For example, to update the name field of a contact, the caller can create an instance of a ChangeDefinition object, populate the object with two nodes (e.g., one that describes the item type and one that contains the field name). A client can then pass at least one of a compiled version of the ChangeDefinition and a list of the corresponding values to the UpdateItem method which makes the modifications in the store. It is to be appreciated that the substantially similar pattern can apply for modifying a filed in an item extension and/or link.

A ChangeDefinition instance models each property change utilizing a tree structure where each level in the tree can correspond to a nested level of properties within the object type. A change to a property value is represented by a leaf node, which is called an assignment node. The assignment node type can be assignment. These nodes can represent an assignment to a property and contain a property name. The non-leaf nodes (except the root) represent a nested type that is a member of either top level property and/or another nested type property. This can be referred to as a traversal node. Traversal nodes contain a list of nodes (assignment or traversal) and optionally a type that is used by the store for implementing the appropriate cast. The traversal node type is PathComponent.

The data structure component 608 can build a ChangeDefinition by creating traversal and assignment nodes. For instance, the nodes can be added by the ChangeDefinition, wherein the ChangeDefinition class has methods for creating nodes and walking the tree. In one example, the ChangeDefinition class is not a user-defined type (UDT). In another example, the following are defined assignment types: 1) assign a scalar value at a depth; 2) assign a nested type instance at a depth; and 3) assign a collection (e.g., multiset and/or sqlList) at a depth. It is to be appreciated and understood that scalar properties (e.g., XML and FileStream properties) can be replaced. In another example, such scalar properties are partially updated. Once the tree is complete, the data structure component 608 can utilize the Compile method, which can return a description of properties that can be changed in a binary format (e.g., also referred to as a compiled change definition). In one example, the value can be passed in as the changeDefinition parameter in the Update method.

The following is an example of one implementation of the data structure component 608, and is not to be seen as a limitation of the subject invention. A caller can be responsible for building the list of values that correspond to the properties described in the ChangeDefinition tree. When the caller adds an assignment node to the ChangeDefinition tree, an index can be assigned to the assignment node. The index can be equal to n−1 (where n is the number of insertions into the tree so far). For instance, the first assignment node gets index zero, the second assignment node gets index one, etc. The index can also be returned to the caller of addAssignment. The caller then constructs an AssignmentValue object that contains the value of the property added to the ChangeDefinition tree. The AssignmentValue is then added into the AssignmentValueList such that its location in the AssignmentValueList can map to the index in the assignment node of the ChangeDefinition tree. The assignment node can be added to the ChangeDefinition and the corresponding AssignmentValue object can be added to the AssignmentValue list using the add method, which appends the AssignmentValue object to the end of the list. The resulting AssignmentValueList is the value that is passed in for the valueList parameter of the Update methods

The data manipulation component 604 can further include an error component 610 to handle an error associated with an operation and/or data manipulation that conflicts with a characteristic of the data storage system 602. For instance, the API 606 ensures the current item domain, wherein the item domain is a logical area that the item defines and/or includes with associated properties, entities, and/or sub-entities. If an item is referenced (e.g., either through an item or through a link, item extension, or item fragment) that is outside the item domain, the item will appear as if it does not exist. In other words, the error code “The item does not exist” can be employed.

The error component 610 can invoke error codes. The error code can be implemented to signify the data manipulation incomplete, wherein the error code can correspond to text describing an error. The procedures and/or operations relating to the manipulation of data within the data storage system 602 can return an integer value that can be the return code for the function (e.g., delete, copy, move, get, set, update, . . . ). In one example, the value can be zero if the operation is successful or a non-zero value if the operation failed. Each respective manipulation procedure/operation and/or function can be associated to an error code. For example, the API 606 can return an error code, rather than displaying text. The error code can then be linked to a corresponding text message, wherein the text messages can be retrieved if necessary from a table in the database.

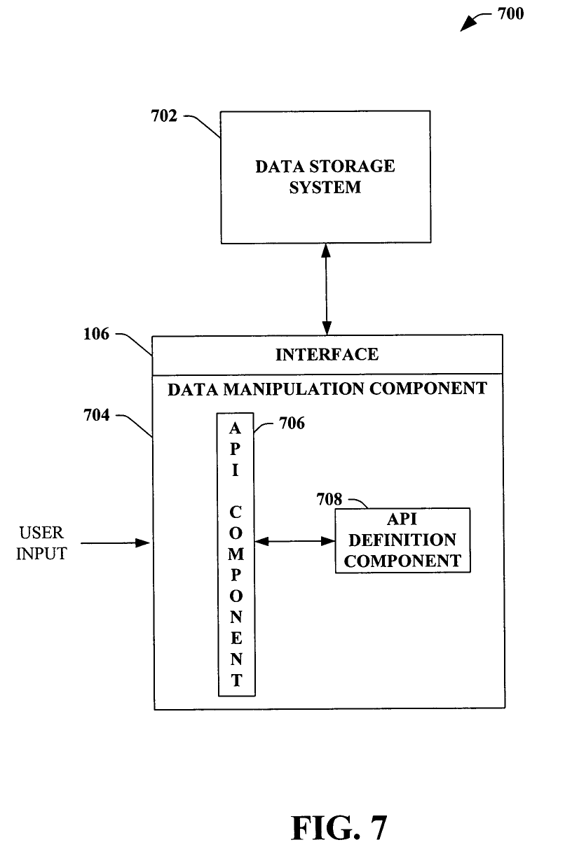

FIG. 7 illustrates a system 700 that facilitates manipulating data within a data storage system utilizing an API component. A data storage system 702 can be a database-based file storage system based at least in part upon a data model, wherein data is represented as instances of complex types. A data manipulation component 704 can provide data manipulation associated to the data storage system 702 while ensuring the enforcement of at least one characteristic associated to the data storage system 702. The data manipulation component 704 can invoke an API component 706 (herein referred to as the “API 706”). The API 706 can provide the data manipulations (e.g., copy, update, replace, get, set, create, delete, move, . . . ) by executing the stored procedures respective to a received user input. The API 706 can receive a user input respective to a data manipulation request/command, wherein such user input is executed while ensuring the integrity and/or purity of the characteristics associated to the data storage system 702. It is to be appreciated that the data storage system 702, the data manipulation component 704, and the API 706 can be substantially similar to the data storage system 602, 502, 402, 302, and 202, the data manipulation component 604, 504, 404, 304, and 204, the API 606, 506, 406 in FIGS. 6, 5, 4, 3, and 2 respectively.

The data manipulation component 704 can include an API definition component 708 that defines procedures and/or operations that allow a user to manipulate data associated to the data storage system 702 without invalidating any data model (utilized to develop the data storage system 702) constraints. The API definition component 708 can implement any suitable function and/or procedure in relation to the manipulation of data within the data storage system 702. It is to be appreciated that the following description of procedures is an example and the subject invention is not so limited. Moreover, the following procedure reference names, functionality, properties, and descriptions are not to be limiting on the subject invention.

The API definition component 708 can utilize a procedure to create an item within the data storage system 702 and more particularly to create an item within a store within the data storage system 702. For example, the following table provides the parameters associated with the create item procedure.

| Name | Direction | Type | Description |
|---|---|---|---|
| Item | IN | [System.Storage.Store]. | The item to be stored. |
| | | Item | |
| namespaceName | IN | NVARCHAR(255) | The namespaceName |
| | | | stored and used in the |
| | | | data storage system |
| | | | namespace. This name |
| | | | must be non-null and |
| | | | non-empty string or an |
| | | | error is returned. |
| securityDescriptor | IN | [System.Storage.Store]. | A security descriptor that |
| | | SecurityDescriptor | is immediately applied to |
| | | | the newly created item. |
| | | | It is a binary form of the |
| | | | security descriptor. This |
| | | | parameter is optional and |
| | | | can be null. In that case |
| | | | the security is inherited |
| | | | from the containing item. |
| | | | Default value is null. |
| promotionStatus | IN | INTEGER | The promotion value to |
| | | | be stored for the item. If |
| | | | the value is non-null and |
| | | | the item is not a root |
| | | | File-Backed item (e.g., |
| | | | isFilebacked != TRUE) |
| | | | an error is returned. A |
| | | | value of STALE is set if |
| | | | the parameter is set to |
| | | | null and the item is a root |
| | | | File-Backed item. |
| | | | Default value is null. |
| isFileBacked | IN | BIT | Specifies whether the |
| | | | item is a file backed item. |
| | | | If isFileBacked is set to |
| | | | TRUE the isFileBacked |
| | | | bit associated with the |
| | | | item is set to TRUE and a |
| | | | zero length file stream is |
| | | | created and associated |
| | | | with this item. An error |
| | | | is returned if any of the |
| | | | ancestors of the item is a |
| | | | File-Backed Item. |
| | | | Default value is null. |
| concurrencyToken | OUT | BIGINT | When the procedure |
| | | | returns this variable |
| | | | contains the |
| | | | concurrencyToken |
| | | | associated with the |
| | | | creation of this item. |
| | | | Default value is null. |
| isGhost | IN | BIT | Specifies whether the |
| | | | item should be ghosted. |
| | | | This parameter must be |
| | | | null for callers without |
| | | | permission to use this |
| | | | parameter. If isGhost is |
| | | | set to TRUE and the item |
| | | | is not a root File-Backed |
| | | | item an error is returned. |
| | | | Default value is null. |
| itemSyncInfo | IN | [System.Storage.Store]. | Must be null if caller is |
| | | SyncEntityVersion | not Sync. Default value |
| | | | is null. |
| itemSyncMetadata | IN | [System.Storage.Store]. | Must be null if caller is |
| | | ItemSyncMetadata | not Sync. Default value |
| | | | is null. |

As depicted above, the create item procedure can have various error codes associated therewith based at least in part upon ensuring the constraints related to the data storage system 702. Such error codes can be any suitable format, wherein the code can represent a text message describing the corresponding error. For example, an error code can be generated when a user attempts to create a file-backed folder. In another example, an error code can be generated if an item of type generic file is not file-backed.

Following the example procedure of create item, each item has a property called ContainerId, which is the ItemId of the container Item. The container item must already exist in the store and be reachable from the client's connection point. If the caller doesn't provide a CreationTime (e.g., provides a value of null) on the item, the store will set the CreationTime to the current time. If the caller does not provide a LastModificationTime (e.g., provides a value of null) on the item the store will set the LastModificationTime to the current time. If both values are not provided, the store will provide the item.CreationTime and item.LastModification times generated will be substantially similar.

In another example, the API definition component 708 can employ a SecurityDescriptor. The inclusion of an optional SecurityDescriptor satisfies the requirement for a client to be able to automatically create a new item and explicitly set security and verification parameters. It is to be appreciated that the SecurityDescriptor can work in conjunction with a security component (not shown) as discussed supra. Furthermore, the API definition component 708 can define the implementation of a tombstoned item. If a tombstoned item exists in the store that has exactly the same item id as the one passed into the procedure, the procedure will not fail. The tombstoned item will be resurrected and the new data passed into this call to CreateItem will be put into the resurrected item.

As discussed supra, a concurrencyToken is returned to enable clients to use optimistic concurrency detection on subsequent updates to the item. The concurrencyToken returned is the token for the item. In another example, when a file system agent calls CreateItem, the API component 706 will not generate an audit. The call will be made in the context of the user (e.g., exec_as_htoken) and the access check will be done in the API 706. A file system (e.g., a traditional file storage system, wherein a bit-based system employs an API of similar bit-size in conjunction with an operating system) audit for this event will be generated by file system agent. Moreover, the API definition component 708 can provide various enforcements in relation to a file-backed item. For instance, if the item is a file-backed item (e.g., isFileBacked” flag is set to true), then the following can apply: 1) FileBackedItem cannot be contained in another filebacked item tree (e.g., for the parent item, EntityState.RootFileBackedItemId should be NULL); and 2) Only items that are declared to be of “CompoundItem” type can be file backed.

The API definition component 708 can implement a procedure to create at least one complex item. The procedure can create multiple items in the store associated with the data storage system 702. It is to be appreciated that the API definition component 708 can create a set of item extensions and a set of links with each item. The type ComplexItem is an immutable UDT. It is essentially a container to pass the data associated with the operation/procedure. The following is an example definition of a ComplexItem.

```
public class ComplexItem
{
  Public ComplexItem( Item item,
          SqlInt32promotionStatus,
          SqlBoolean isFileBacked,
          SqlString namespaceName,
          SqlBoolean isGhost,
          SyncEntityVersion syncInfo,
          ItemSyncMetadata syncMetadata);
  public void AddLink(Link link,
      SyncEntityInformation syncInfo,
      LinkSyncMetadata syncMetadata);
  public void AddItemExtension(ItemExtension itemExtension,
            SyncEntityVersion syncInfo);
  public void AddItemFragment(ItemFragment itemFragment,
            SyncEntityVersion syncInfo);
}
```

Moreover, the following table provides an example of the parameters associated with the create complex item procedure.

| Name | Direction | Type | Description |
|---|---|---|---|
| ComplexItems | IN | [System.Storage.Store]. | A list of one or more |
| | | ComplexItemList | ComplexItem instances. |
| securityDescriptor | IN | [System.Storage.Store]. | A security descriptor that |
| | | SecurityDescriptor | is immediately applied to |
| | | | all the newly created |
| | | | items. The string is the |
| | | | binary form of the |
| | | | security descriptor. This |
| | | | parameter is optional and |
| | | | can be null. In that case |
| | | | the security for all the |
| | | | items is inherited from |
| | | | the source of the |
| | | | containing item. Default value |
| | | | is null. |
| concurrencyToken | OUT | BIGINT | When the procedure |
| | | | returns the |
| | | | concurrencyToken |
| | | | contains the value |
| | | | associated with the |
| | | | creation of all the items, |
| | | | links, and item |
| | | | extensions created. |
| | | | Default value is null. |

It is to be appreciated that the API definition component 708 can provide the following functionality. The transaction semantics are such that the all the items are added atomically. If there are any failures during the function, none of the complex items are inserted into the store. If the complexItems list is empty then the operation is noop and returns success. If a tombstoned item exists in the store that has the same item ID as any of the ones passed into the procedure, the procedure will fail. The item extensions list can be null or non-null with zero or more entries. The links list can be null or non-null with zero or more entries. The item fragments list can be null or non-null with zero or more entries. A concurrencyToken is returned to enable clients to use optimistic concurrency detection on subsequent updates. The concurrencyToken value will apply to all the items, links, and item extensions created as a result of this operation. In regards to a file-backed item, the following can apply: 1) FileBackedItem cannot be contained in another filebacked item tree (e.g., for the parent item, EntityState.RootFileBackedItemId should be NULL); and 2) Only items that are declared to be of “CompoundItem” type can be file backed.

The API definition component 708 can implement a procedure to create a link in the store within the data storage system 702. For example, the following table can depict various parameters associated to the procedure utilized to create a link.

| Name | Direction | Type | Description |
|---|---|---|---|
| link | IN | [System.Storage.Store]. | The link. |
| | | Link | |
| concurrencyToken | OUT | BIGINT | When the procedure |
| | | | returns the |
| | | | concurrencyToken |
| | | | contains the value |
| | | | associated with the |
| | | | creation of this link. |
| | | | Default value is null. |
| syncInfo | IN | [System.Storage.Store]. | Must be null if caller is |
| | | SyncEntityVersion | not Sync. Default value is null. |
| syncMetadata | IN | [System.Storage.Store]. | Must be null if caller is |
| | | LinkSyncMetadata | not Sync. Default value is null. |

It is to be appreciated that the API definition component 708 ensures various characteristics associated to the data storage system 702. For instance, the target item id can either point to a valid item of the correct type (as specified in the schema for this link type) and/or the target item id must be null. The CreateLink can be utilized to create one link between existing data storage system 702 items. It is to be appreciated that if a tombstoned link exists in the store that has the substantially similar link id and source item id as the one passed into the procedure, the procedure will not fail. The tombstoned link can be resurrected and the new data passed into this call to CreateLink will be put into the resurrected link. Additionally, a concurrencyToken can be returned to enable clients to use optimistic concurrency detection on subsequent updates to this link.

The API definition component 708 can employ a procedure to create an item extension within the store. For example, the following table can depict various parameters associated to the procedure utilized to create the item extension.

| Name | Direction | Type | Description |
|---|---|---|---|
| itemExtension | IN | [System.Storage.Store]. | An instance of a UDT |
| | | ItemExtension | which extends an |
| | | | ItemExtension. |
| itemId | IN | [System.Storage.Store]. | The item id of the item |
| | | ItemId | with which the |
| | | | ItemExtension is to be |
| | | | associated. |
| concurrencyToken | OUT | BIGINT | When the procedure |
| | | | returns the |
| | | | concurrencyToken, it |
| | | | contains the value |
| | | | associated with the |
| | | | creation of this item |
| | | | extension. Default value is null. |
| syncInfo | IN | [System.Storage.Store]. | Must be null if caller is |
| | | SyncEntityVersion | not Sync. Default value is null. |

The concurrencyToken utilized above, can be returned to enable a client to utilize optimistic concurrency detection on subsequent updates to this item extension.

The API definition component 708 can invoke a procedure to modify an item within the store, wherein the store is persisted data related to the data storage system 702. The table below is an example of parameters and descriptions corresponding to the modification of an item procedure.

| Name | Direction | Type | Description |
|---|---|---|---|
| itemId | IN | [System.Storage. | Id of the item to update. |
| | | Store].ItemId | |
| compiledChangeDefinition | IN | [System.Storage. | A description of the |
| | | Store].CompiledChangeDefinition | properties in the Item |
| | | | will be modified. |
| valueList | IN | [System.Storage. | The set of values to be |
| | | Store].AssignmentValueList | applied to the properties |
| | | | in ChangeDefinition. |
| promotionStatus | IN | INTEGER | The promotion value to |
| | | | be stored for the item. |
| | | | This parameter is ignored |
| | | | if the item is not a File- |
| | | | Backed Item. The value |
| | | | remains unchanged if |
| | | | null is passed. |
| concurrencyToken | IN OUT | BIGINT | On input the |
| | | | concurrencyToken is the |
| | | | expected value of the |
| | | | item. When the |
| | | | procedure returns the |
| | | | concurrencyToken, it |
| | | | contains the value |
| | | | associated with this |
| | | | update of the item. If the |
| | | | input value is null no |
| | | | check is done. The new |
| | | | concurrencyToken is still |
| | | | returned. Default value |
| | | | is null. |
| syncInfo | IN | [System.Storage. | Must be null if caller is |
| | | Store].SyncEntityVersion | not Sync. Default value |
| | | | is null. |
| syncMetadata | IN | [System.Storage. | Must be null if caller is |
| | | Store].ItemSyncMetadata | not Sync. Default value |
| | | | is null. |

The API definition component 708 can invoke a procedure to modify a link in the store. The table below is an example of parameters and descriptions corresponding to the modification of a link procedure.

| Name | Direction | Type | Description |
|---|---|---|---|
| sourceItemId | IN | [System.Storage. | The id of the link's |
| | | Store].ItemId | source item. |
| linkId | IN | [System.Storage. | The id of the link to |
| | | Store].LinkId | update. |
| compiledChangeDefinition | IN | [System.Storage. | A description of the |
| | | Store].CompiledChangeDefinition | properties in the Item |
| | | | will be modified. |
| valueList | IN | [System.Storage. | The set of values to be |
| | | Store].AssignmentValueList | applied to the properties |
| | | | in ChangeDefinition. |
| concurrencyToken | IN OUT | BIGINT | On input the |
| | | | concurrencyToken is the |
| | | | expected value of the |
| | | | link. When the |
| | | | procedure returns the |
| | | | concurrencyToken, it |
| | | | contains the value |
| | | | associated with this |
| | | | update of the link. If the |
| | | | input value is null no |
| | | | check is done. The new |
| | | | concurrencyToken is still |
| | | | returned. Default value |
| | | | is null. |
| syncInfo | IN | [System.Storage. | Must be null if caller is |
| | | Store].SyncEntityVersion | not Sync. Default value |
| | | | is null. |
| syncMetadata | IN | [System.Storage. | Must be null if caller is |
| | | Store].LinkSyncMetadata | not Sync. Default value |
| | | | is null. |

The source of a link is immutable, and cannot be changed by using this stored procedure. The target of a link is mutable and can be changed by calling UpdateLink. The type of the target item id may be null or non-null. If it is non-null, it can point to an item that exists in the store and it can match the type declared on the link

In addition, the API definition component 708 can modify an ItemExtension in the store. The following table is an example of a procedure utilized by the API definition component 708 and illustrates various properties and/or descriptions associated therewith.

| Name | Direction | Type | Description |
|---|---|---|---|
| itemId | IN | [System.Storage.Store]. | The id of the item |
| | | ItemId | with which the |
| | | | target item |
| | | | extension is |
| | | | associated. |
| typeId | IN | [System.Storage.Store]. | The type id of the |
| | | TypeId | item extension. |
| compiledChangeDefinition | IN | [System.Storage.Store]. | Describes which |
| | | CompiledChangeDefinition | properties in the |
| | | | item extension |
| | | | will be modified. |
| valueList | IN | [System.Storage.Store]. | The set of values |
| | | AssignmentValueList | to be applied to |
| | | | the properties in |
| | | | ChangeDefinition. |
| concurrencyToken | IN OUT | BIGINT | On input the |
| | | | concurrencyToken |
| | | | is the expected |
| | | | value of the |
| | | | extension. When |
| | | | the procedure |
| | | | returns the |
| | | | concurrencyToken |
| | | | contains the |
| | | | value associated |
| | | | with this update |
| | | | of the item |
| | | | extension. If the |
| | | | input value is null |
| | | | no check is done. |
| | | | The new |
| | | | concurrencyToken |
| | | | is still returned. |
| | | | Default value is |
| | | | null. |
| syncInfo | IN | [System.Storage.Store]. | Must be null if |
| | | SyncEntityVersion | caller is not Sync. |
| | | | Default value is |
| | | | null. |

Moreover, the API definition component 708 can invoke a procedure with the API 706 that allows an item to be deleted within the store. Below is a table with example parameters and descriptions of the procedure to delete an item from the store.

| Name | Direction | Type | Description |
|---|---|---|---|
| itemId | IN | [System.Storage.Store]. | The ItemId of the Item to |
| | | ItemId | be deleted. |
| concurrencyToken | IN | BIGINT | Expected value of the |
| | | | concurrencyToken for |
| | | | this Item. If the value is |
| | | | null no check is done. |
| | | | Default value is null. |
| deletionUtc | IN | DATETIME | Must be null if caller is |
| | | | not Sync. Default value |
| | | | is null. |
| syncVersion | IN | [System.Storage.Store]. | Must be null if caller is |
| | | SyncEntityVersion | not Sync. Default value is |
| | | | null. |

In the case the item is not found, the procedure will return success. Any links in the store which target the item can have the TargetItemId property set to null. Setting the TargetItemId to null can succeed regardless of the effective permissions the caller has on the Links. When deleting an item, links sourced from the item, ItemExtensions and ItemFragments associated with the item can be deleted. The delete can be successful if the item has no children (e.g., there exist no items with a container id equal to itemid). In one example, there is no way to force a cascade delete of a tree of items. This can only be implemented by the caller. If the item id is tombstoned, success is returned regardless of the state of the concurrencyToken/LastUpdateTS values. If the concurrencyToken does not match and the item is NOT tombstoned, an error code can be returned. The file system agent can call DeleteItem in its own context. No access checks or audits would done in the API 706.

The API definition component 708 can invoke a procedure to delete a link in the store. The table below is an example of parameters and descriptions corresponding to the deletion of a link procedure.

| Name | Direction | Type | Description |
|---|---|---|---|
| sourceItemId | IN | [System.Storage. | The ItemId of the source item |
| | | Store].ItemId | for the link to be deleted. |
| linkId | IN | [System.Storage. | The id of the link to be deleted. |
| | | Store].LinkId | |
| concurrencyToken | IN | BIGINT | Expected value of the |
| | | | concurrencyToken for this |
| | | | link. If the value is null no |
| | | | check is done. Default value is |
| | | | null. |
| deletionUtc | IN | DATETIME | Must be null if caller is not |
| | | | Sync. Default value is null. |
| syncVersion | IN | [System.Storage. | Must be null if caller is not |
| | | Store].SyncVersion | Sync. Default value is null. |

The API definition component 708 can employ a procedure to delete an item extension in the store within the data storage system 702. The following table is an example of parameters and descriptions corresponding to the deletion of an item extension procedure utilized with the subject invention.

| Name | Direction | Type | Description |
|---|---|---|---|
| itemId | IN | [System.Storage.Store]. | The id of the item with |
| | | ItemId | which the target item |
| | | | extension is associated. |
| typeId | IN | [System.Storage.Store]. | The type id of the item |
| | | TypeId | extension. |
| concurrencyToken | IN | BIGINT | Expected value of the |
| | | | concurrencyToken of the |
| | | | item extension. If the |
| | | | value is null no check is |
| | | | done. Default value is |
| | | | null. |
| deletionUtc | IN | DATETIME | Must be null if caller is |
| | | | not Sync. Default value |
| | | | is null. |
| syncVersion | IN | [System.Storage.Store]. | Must be null if caller is |
| | | SyncVersion | not Sync. Default value is |
| | | | null. |

In addition, the API definition component 708 can employ a procedure to create an ItemFragment in the store. The following table is an example of parameters and descriptions corresponding to the procedure that allows a user to create an ItemFragment.

| Name | Direction | Type | Description |
|---|---|---|---|
| itemFragment | IN | [System.Storage.Store]. | The item fragment to be |
| | | ItemFragment | created. The FragmentId |
| | | | of the ItemFragment is |
| | | | stored inside the udt. |
| concurrencyToken | OUT | BIGINT | When the procedure |
| | | | returns the |
| | | | concurrencyToken, it |
| | | | contains the value |
| | | | associated with the |
| | | | creation of this |
| | | | ItemFragment. Default |
| | | | value is null. |
| syncInfo | IN | [System.Storage.Store]. | Must be null if caller is |
| | | SyncEntity Version | not Sync. Default value is |
| | | | null. |

The API definition component 708 can invoke a procedure to modify an ItemFragment in the store. This stored procedure can be generated per type such that the name of the type and the name of the ItemFragment property will be contained in the name of the stored procedure. For more clarification, reference the “CreateItemFragment” as discussed supra. The following table is an example of parameters and descriptions corresponding to the modification of an ItemFragment in the store.

| Name | Direction | Type | Description |
|---|---|---|---|
| itemId | IN | [System.Storage. | The item id of the item |
| | | Store].ItemId | fragment to update. |
| setId | IN | [System.Storage. | The identifier of the item |
| | | Store].SetId | fragment property to |
| | | | update. |
| fragmentId | IN | [System.Storage. | The fragment id of the |
| | | Store].FragmentId | fragment to update. |
| compiledChangeDefinition | IN | [System.Storage. | A description of the |
| | | Store].CompiledChange | ItemFragment properties |
| | | Definition | to modify. |
| valueList | IN | [System.Storage. | The set of values to be |
| | | Store].Assignment | applied to the properties |
| | | ValueList | in ChangeDefinition. |
| concurrencyToken | IN OUT | BIGINT | On input the |
| | | | concurrencyToken is the |
| | | | expected value of the |
| | | | ItemFragment. When the |
| | | | procedure returns the |
| | | | concurrencyToken |
| | | | contains the value |
| | | | associated with this |
| | | | update of the |
| | | | ItemFragment. If the |
| | | | input value is null no |
| | | | check is done. The new |
| | | | concurrencyToken is still |
| | | | returned. Default value |
| | | | is null. |
| syncInfo | IN | [System.Storage. | Must be null if caller is |
| | | Store].SyncEntityVersion | not Sync. Default value |
| | | | is null. |

The API definition component 708 can define and/or implement a procedure to delete an ItemFragment in the store. Below is a table that depicts various parameters as an example of the procedure to delete the ItemFragment within the data storage system 702.

| Name | Direction | Type | Description |
|---|---|---|---|
| itemId | IN | [System.Storage.Store]. | The ItemId of the source Item |
| | | ItemId | for the ItemFragment to be |
| | | | deleted. |
| setId | IN | [System.Storage.Store]. | The identifier of the item |
| | | SetId | fragment property to delete. |
| fragmentId | IN | [System.Storage.Store]. | The fragment id of the |
| | | FragmentId | fragment to update. |
| concurrencyToken | IN | BIGINT | Expected value of the |
| | | | concurrencyToken for this |
| | | | ItemFragment. If the value is |
| | | | null no check is done. |
| | | | Default value is null. |
| deletionUtc | IN | DATETIME | Must be null if caller is not |
| | | | Sync. Default value is null. |
| syncVersion | IN | [System.Storage.Store]. | Must be null if caller is not |
| | | SyncVersion | Sync. Default value is null. |

Moreover, the API definition component 708 can employ a procedure that obtaining the security descriptor of an item. The table below is an example of various parameters associated with a procedure to get the security descriptor of an item within the data storage system 702.

| Name | Direction | Type | Description |
|---|---|---|---|
| itemId | IN | [System.Storage. | The id of the Item whose |
| | | Store].ItemId | security descriptor should |
| | | | be retrieved. |
| securityInfoFlags | IN | INTEGER | A set of flags indicating |
| | | | which parts of the security |
| | | | descriptor are to be |
| | | | returned. |
| securityDescriptor | OUT | [System.Storage.Store]. | The security descriptor. |
| | | SecurityDescriptor | |
| concurrencyToken | OUT | BIGINT | When the procedure |
| | | | returns this variable |
| | | | contains the |
| | | | concurrencyToken value |
| | | | associated with this update |
| | | | of the security descriptor. |
| | | | Default value is null. |

The concurrencyToken is returned to enable clients to use optimistic concurrency detection on subsequent updates to the security descriptor. The concurrencyToken can be associated with the security descriptor. In one example, the concurrencyToken for the security descriptor is not related to the concurrencyToken value of item that corresponds to the itemid. The file system agent can call GetItemSecurity in its own context.

The API definition component 708 can set the security descriptor of an item in the store. The following table is an example of a procedure to set the security descriptor utilized by the API 706 and illustrates various properties and/or descriptions associated therewith.

| Name | Direction | Type | Description |
|---|---|---|---|
| itemId | IN | [System.Storage.Store]. | The id of the Item whose |
| | | ItemId | security descriptor should |
| | | | be retrieved. |
| securityInfoFlags | IN | INTEGER | A set of flags indicating |
| | | | which parts of the |
| | | | security descriptor are |
| | | | being updated. |
| securityDescriptor | IN | [System.Storage.Store]. | The security descriptor. |
| | | SecurityDescriptor | |
| concurrencyToken | IN OUT | BIGINT | On input is this is the |
| | | | expected value of the |
| | | | concurrencyToken of the |
| | | | security descriptor. |
| | | | When the procedure |
| | | | returns this variable |
| | | | contains the |
| | | | concurrencyToken |
| | | | associated with this |
| | | | update of the security |
| | | | descriptor. If the input |
| | | | value is null no check is |
| | | | done. The new |
| | | | concurrencyToken value is |
| | | | still returned. Default |
| | | | value is null. |

The API definition component 708 can employ a procedure that moves an Item from one container to another and/or change the namespaceName of the item. The table below is an example of various parameters associated with such procedure.

| Name | Direction | Type | Description |
|---|---|---|---|
| itemId | IN | [System.Storage.Store]. | The ItemId of the item to |
| | | ItemId | be moved. |
| newContainerId | IN | [System.Storage.Store]. | The Id of the container to |
| | | ItemId | move the Item to. If null is |
| | | | passed the container id |
| | | | remains unchanged. |
| namespaceName | IN | NVARCHAR (255) | The value of the |
| | | | namespaceName name. If |
| | | | null is passed the name |
| | | | remains unchanged. It is |
| | | | an error to pass in empty |
| | | | string. *See the notes |
| | | | section for details on the |
| | | | real declared length of the |
| | | | type. |
| concurrencyToken | IN OUT | BIGINT | Expected value of the |
| | | | concurrencyToken for this |
| | | | iItem. If the value is null |
| | | | no check is done. Default |
| | | | value is null. |

If either the item to be moved or the new container is not reachable from the current connection point, the procedure can return an error. This operation can fail if the item with the same name already exists in the target container. There are three valid ways to use this function. These usages are captured in the table below:

| namespaceName | newContainerId | Result |
|---|---|---|
| Null | Null | Error |
| Null | Non-null | Moves the item but keeps the same |
| | | namespaceName. |
| Non-null | Null | Does not move the item and |
| | | changes the namespaceName. |
| Non-null | Non-null | Moves the item to a new container |
| | | and changes the namespaceName. |

Regardless of how MoveItem is called (e.g., either to move the item and/or to rename the item) the LastUpdateTS value (as returned in the concurrencyToken) for the Item can be updated. The file system agent can call MoveItem in the context of the user. No access checks or audits on the file/directory being renamed. Access checks and audit done on the new parent determines whether the user has access to move the item to the new destination.

The API definition component 708 can employ a procedure that replaces an Item with a new Item, which can be of a different type. The table below is an example of various parameters associated with such procedure.

| Name | Direction | Type | Description |
|---|---|---|---|
| newItem | IN | [System.Storage. | The item to replace the |
| | | Store].ItemId Item | existing item in the |
| | | | store. |
| deleteItemOwnedContent | IN | BIT | If this parameter is |
| | | | TRUE all item owned |
| | | | content (links sourced |
| | | | from the item, item |
| | | | extensions, file streams |
| | | | attached to the item) |
| | | | will be deleted. |
| concurrencyToken | IN OUT | BIGINT | On input the |
| | | | concurrencyToken is |
| | | | the expected value of |
| | | | the item. When the |
| | | | procedure returns the |
| | | | concurrencyToken |
| | | | contains the value |
| | | | associated with this |
| | | | update of the item. If |
| | | | the input value is null |
| | | | no check is done. The |
| | | | new concurrencyToken |
| | | | is still returned. |
| | | | Default value is null. |
| syncInfo | IN | [System.Storage. | Must be null if caller is |
| | | Store].SyncEntityVersion | not Sync. Default |
| | | | value is null. |

The ReplaceItem operation can be used to replace an Item object with another item object. These objects can be referred to as the OldItem and NewItem. OldItem and NewItem may have the same ItemId, but can have different types. For instance, one application where this operation will be used is Property promotion. The following description can be associated with the ReplaceItem operation: 1) The container ID cannot be changed (to get this functionality the caller must call MoveItem); 2) The existing namespaceName will not change; 3) Always delete all items that are sourced from the Item being replaced if the item is file-backed; 4) If the replace item operation will cause a link that targets the item to be invalid (because the target type constraint is no longer valid), ReplaceItem fails; 5) If the replace item operation will cause a link that is sourced from the item to be invalid (because the source type constraint is no longer valid), ReplaceItem fails; 6) The change units of the new item are all set to default values. There can be at least two exceptions. If the item participates in sync then can carry over the ChangeInformation.SyncInformation.CreationSyncVersion value from the old item to the new item. In addition, if the item participates in sync and is file backed the change unit for the file stream is carried over from the old item to the new item; 7) All the file based properties have to be specified. Unlike CreateItem, there is no inheritance of File properties from the parent folder if they are not set by the user; 8) For file backed items, any file stream data is not modified unless the DeleteItemOwnedContent flag is specified (See table below);

| OldItem | NewItem type | Behavior |
|---|---|---|
| Non-file backed | File backed | Not allowed; ReplaceItem fails (error code |
| item | item | returned). |
| File backed item | File backed item | Retain old file streams (unless this is overridden |
| | | by the flag DeleteEmbeddedContent). If the |
| | | item participates in Sync then the change unit |
| | | value corresponding to the file stream is carried |
| | | over from the old item to the new item. |
| File backed item | Non-file | Not allowed; ReplaceItem fails (error code |
| | backed item | returned). |
| Non-file backed | Non-file | No special behavior. |
| item | backed item | |

and 9) ReplaceItem does not allow an item to switch from a Generic Item type to a Compound Item type or vice versa (See table below).

| OldItem | NewItem type | Behavior |
|---|---|---|
| Generic | Generic | Allowed |
| Compound | Compound | Allowed |
| Generic | Compound | Not allowed (error code returned) |
| Compound | Generic | Not allowed (error code returned) |

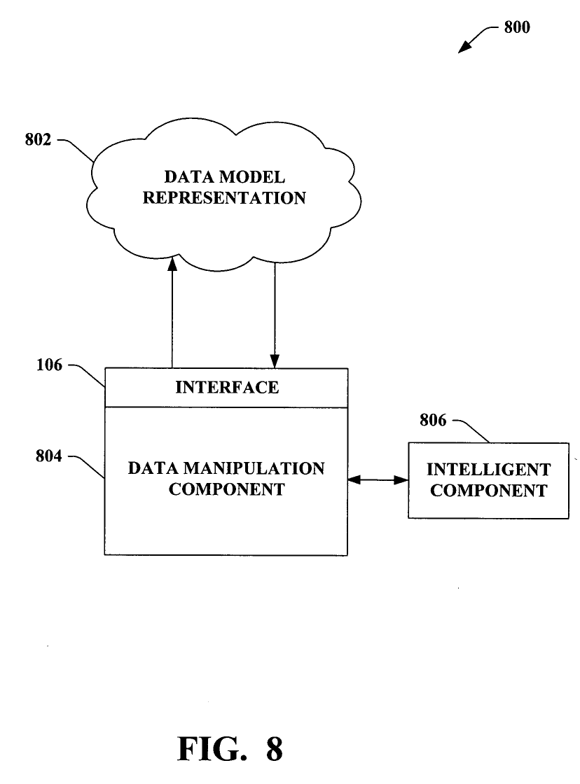

FIG. 8 illustrates a system 800 that employs intelligence to facilitate manipulating data based at least in part upon a data model with respective characteristics. The system 800 can include a data storage system 802 (that can be represented by a data model representation), a data manipulation component 804, and an interface 106 that can all be substantially similar to respective components described in previous figures. The system 800 further includes an intelligent component 806. The intelligent component 806 can be utilized by the data manipulation component 804 to facilitate manipulating data (e.g., a copy, an update, a replace, a get, a set, a create, a delete, a move, . . . ) in accordance with at least one characteristic associated with the data storage system 802. For example, the intelligent component 806 can be utilized to analyze characteristics associated with the data storage system 802 and/or ensure the integrity of the characteristics respective to the data storage system 802.

It is to be understood that the intelligent component 806 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the subject invention.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

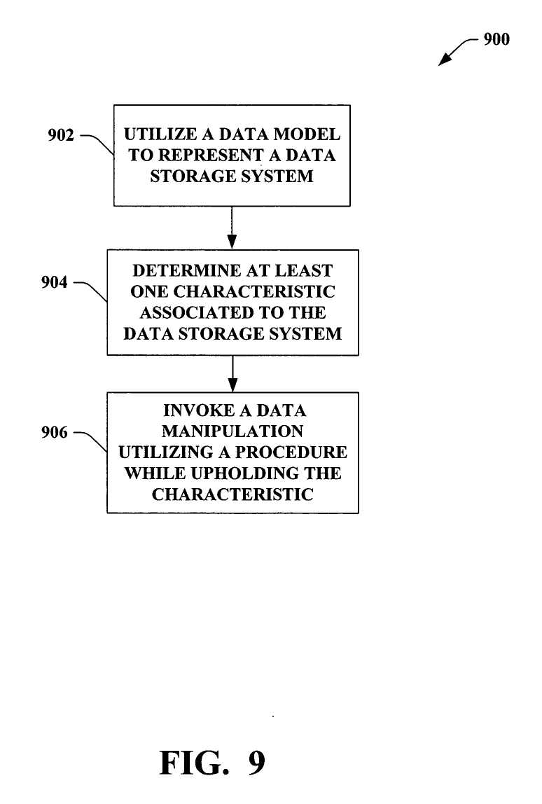

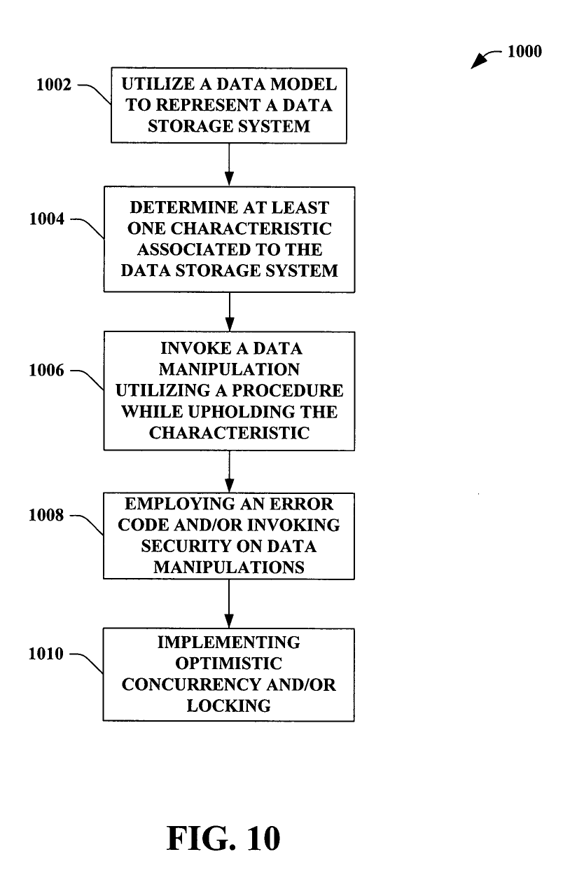

FIGS. 9-10 illustrate methodologies in accordance with the subject invention. For simplicity of explanation, the methodologies are depicted and described as a series of acts. It is to be understood and appreciated that the subject invention is not limited by the acts illustrated and/or by the order of acts, for example acts can occur in various orders and/or concurrently, and with other acts not presented and described herein. Furthermore, not all illustrated acts may be required to implement the methodologies in accordance with the subject invention. In addition, those skilled in the art will understand and appreciate that the methodologies could alternatively be represented as a series of interrelated states via a state diagram or events.

FIG. 9 illustrates a methodology 900 that facilitates invoking a data manipulation within a database-based system while enforcing at least one model constraint. At reference numeral 902, a data model can be utilized to represent a data storage system. The data model can be a complex model based at least in part upon a database structure, wherein an item, a sub-item, a property, and a relationship are defined to allow the representation of information within a data storage system as instances of complex types. The data model can utilize a set of basic building blocks for creating and managing rich, persisted objects and links between objects. It is to be appreciated that the data model can include at least one characteristic that reflects upon the structure and/or functionality of the data storage system represented. In other words, the data model can contain constraints that can be enforced to ensure the integrity of the data model, the data storage system, and data associated therewith.

At reference numeral 904, a characteristic associated with the data storage system (based upon the data model) can be determined. The characteristic, for example, can consist of guidelines, restrictions, blueprints, etc. to provide the data storage system according to such characteristics. By employing such characteristics, the integrity and accuracy of the corresponding data model can be ensured. At reference numeral 906, a data manipulation can be invoked by implementing at least one procedure. While providing any suitable data manipulation in relation the data storage system, the characteristic of such data storage system is enforced to provide a stable environment. In one example, an API can be employed to allow any suitable data manipulation in conjunction with the data storage system. For instance, the API can be utilized by a user, wherein the user can modify data. It is to be appreciated that the data manipulation can include, but is not limited to, a copy, an update, a replace, a get, a set, a create, a delete, a move, etc. For example, the data storage system can include a container hierarchical system, wherein such characteristic is enforced during any procedure utilized to manipulate data within the data storage system.

FIG. 10 illustrates a methodology 1000 for manipulating data based at least in part upon a data model with respective characteristics being enforced. At reference numeral 1002, a data model can be utilized to represent a data storage system. The data storage system can be a database-based file system, wherein information is represented as complex instances of types. At reference numeral 1004, a characteristic associated to the represented data storage system is determined. The characteristic can include, but is not limited to, a restriction, a guideline, a rule, a goal, a blueprint, and/or any other suitable element associated to the data storage system that encourages accurate implementation.

At reference numeral 1006, the manipulation of data can be invoked by utilizing at least one procedure. The data manipulation can be provided by an API, wherein a user can call at least one procedure, wherein the procedure can correspond to at least one data manipulation. It is to be appreciated that the data manipulation is invoked while maintaining and/or enforcing the characteristic(s) associated to the data storage system. At reference numeral 1008, an error code can be utilized and/or security can be employed. The error code can be generated and utilized, for example, when the data manipulation infringes upon the characteristics of the data storage system. It is to be appreciated that the error code can be displayed to a user via the API, wherein the code can correspond to a lookup table that relates the code to a text message. The security associated to the data manipulations and/or the API can include various authorization levels and/or logins and/or passwords. In other words, each data manipulation can be related to a security level, wherein only a certain level of security can implement such procedures and/or a login and password are required.

At reference numeral 1010, optimistic concurrency and/or deadlocking can be implemented in relation to the data manipulations within the data storage system. Optimistic concurrency assumes the likelihood of another process making a change at the substantially similar time is low, so it does not take a lock until the change is ready to be committed to the data storage system (e.g., store). By employing such technique, the lock time is reduced and offers better database performance. In one example, a token can be kept to associate with the item the changes with each modification of the item. In other words, optimistic concurrency can facilitate accessing data between two concurrent applications. In addition, locking can facilitate supporting multiple concurrent callers. For instance, image a scenario where there are multiple concurrent callers who request ownership of a common set of resources in such a way that none of the requests can be satisfied because each caller is waiting on the other. In such a case, the system can block the callers (e.g., lock the callers out), wherein the only way out of such case is to evict one of the callers. To avoid this situation, the locking can support multiple concurrent callers such that a complex locking logic can guarantee individual requests to either succeed or fail automatically. Moreover, multiple concurrent callers can be supported such that a complex locking logic can guarantee individual requests to either succeed or fail atomically.

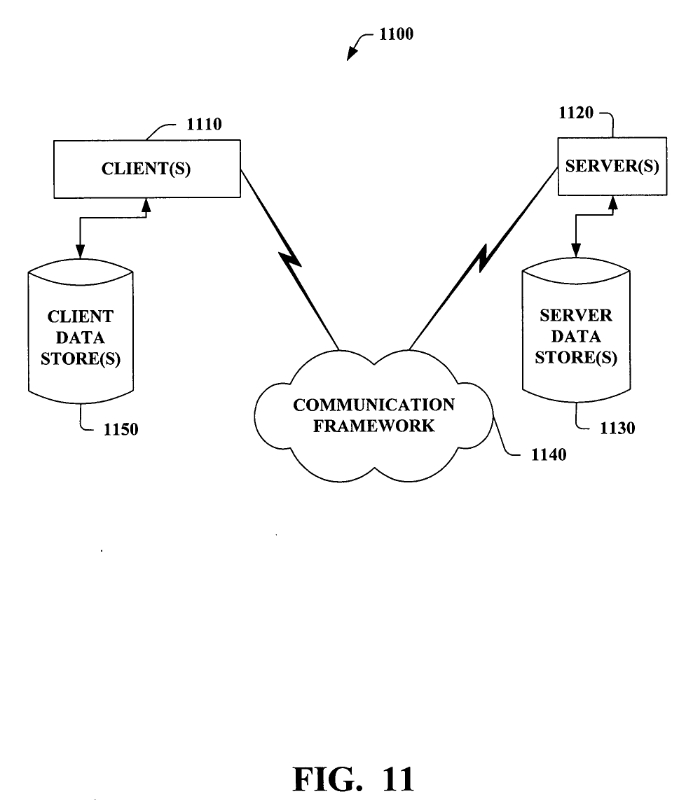

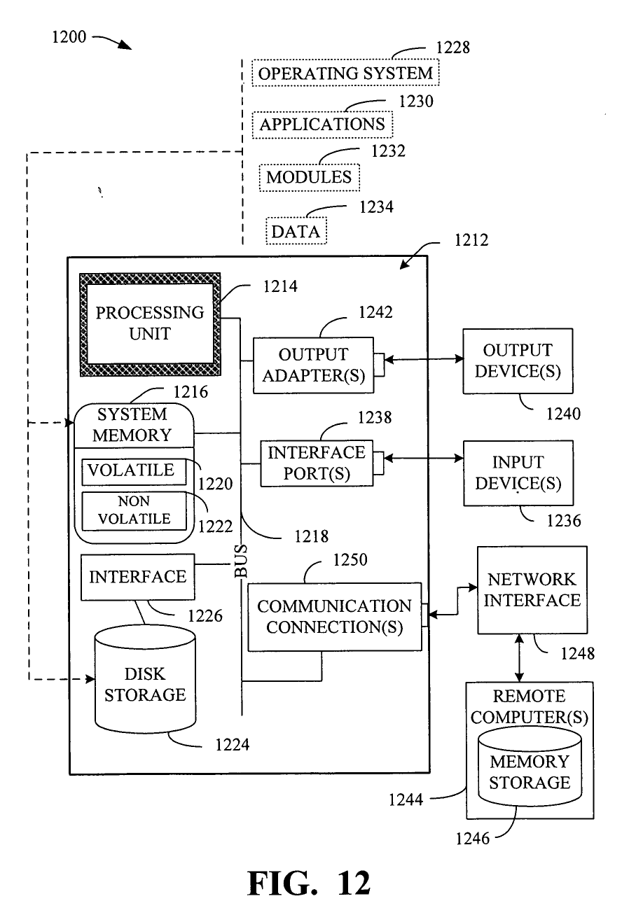

In order to provide additional context for implementing various aspects of the subject invention, FIGS. 11-12 and the following discussion is intended to provide a brief, general description of a suitable computing environment in which the various aspects of the subject invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

FIG. 11 is a schematic block diagram of a sample-computing environment 1100 with which the subject invention can interact. The system 1100 includes one or more client(s) 1110. The client(s) 1110 can be hardware and/or software (e.g., threads, processes, computing devices). The system 1100 also includes one or more server(s) 1120. The server(s) 1120 can be hardware and/or software (e.g., threads, processes, computing devices). The servers 1120 can house threads to perform transformations by employing the subject invention, for example.

One possible communication between a client 1110 and a server 1120 can be in the form of a data packet adapted to be transmitted between two or more computer processes. The system 1100 includes a communication framework 1140 that can be employed to facilitate communications between the client(s) 1110 and the server(s) 1120. The client(s) 1110 are operably connected to one or more client data store(s) 1150 that can be employed to store information local to the client(s) 1110. Similarly, the server(s) 1120 are operably connected to one or more server data store(s) 1130 that can be employed to store information local to the servers 1140.

With reference to FIG. 12, an exemplary environment 1200 for implementing various aspects of the invention includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable programmable ROM (EEPROM), or flash memory. Volatile memory 1220 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1212 also includes removable/non-removable, volatile/non-volatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in the suitable operating environment 1200. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the subject invention can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers, among other output devices 1240, which require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates manipulating data, comprising:
a data model that in part represents complex instances of types and includes at least one of a constraint and a characteristic; and
a data manipulation component that manipulates data associated with the data model and enforces at least one of the constraint and the characteristic.

2. The system of claim 1, the data model represents a data storage system that is a database-based system that defines a hierarchical model of at least one persisted entity and zero or more sub-entities per each entity to represent information as a complex type.

3. The system of claim 1, the manipulation of data is at least one of a copy, an update, a replace, a get, a set, a create, a delete, a move, and a modify.

4. The system of claim 1, further comprising a security component that can employ a security technique that corresponds to the data manipulation to invoke on the data storage system.

5. The system of claim 4, the security technique is at least one of a login, a password, a biometric indicia, a voice recognition, and a security level associated with a user.

6. The system of claim 2, further comprising an API component that persists data associated with the data storage system within a database, wherein at least one procedure is used to enforce at least one of the data model constraint and characteristic.

7. The system of claim 2, further comprising a procedure component that provides at least one procedure to manipulate data in accordance with at least one of the constraint and characteristic associated with the data storage system.

8. The system of claim 2, further comprising an enforcer component that incorporates at least one of a characteristic and constraint of the data storage system with the manipulation of data.

9. The system of claim 2, further comprising a locking component that provides a complex locking logic to guarantee one of the following: an individual request to succeed atomically; and an individual request to fail atomically.

10. The system of claim 2, further comprising an optimistic concurrency component that utilizes an optimistic concurrency technique, wherein such technique assumes the likelihood of a first process making a change at the substantially similar time as a second process is low and a lock is not employed until the change is committed to the data storage system.

11. The system of claim 2, further comprising an error component that can provide an error code when the data manipulation will not enforce at least one of the characteristic and constraint, wherein the error code can correspond to text describing an error and the procedure is not implemented.

12. The system of claim 3, further comprising a data structure component that can employ at least one data structure to be implemented by the API component.

13. The system of claim 12, the data structure component utilizes at least one of a synonym type and a generic list type.

14. The system of claim 12, the data structure component employs a change definition type that provides a granular update, wherein a user can pass changed data to an update method while keeping a size of the procedure proportional to the size of the data changed.

15. The system of claim 3, further comprising an API definition component that defines at least one of the following procedures to be employed with the API component: 1) a create item; 2) a create complex item; 3) a create link; 4) a create item extension; 5) an update item; 6) an update link; 7) an update item extension; 8) a delete item; 9) a delete link; 10) a delete item extension; 11) a create item fragment; 12) an update item fragment; 13) a delete item fragment; 14) a get item security; 15) a set item security; 16) a move item; and 17) a replace item.

16. The system of claim 3, the API component receives an input from a user to manipulate data.

17. A computer readable medium having stored thereon the components of the system of claim 1.

18. A computer-implemented method that facilitates manipulating data, comprising:
utilizing a data model to represent a data storage system that is a database-based file system;
determining at least one of a characteristic and a constraint associated with the data storage system;
manipulating data within the data storage system while enforcing at least one of the characteristic and constraint; and
invoking an API to allow a user to manipulate the data.

19. A data packet that communicates between a data manipulation component and an interface, the data packet facilitates the method of claim 18.

20. A computer-implemented system that facilitates manipulating data, comprising:
means for representing a data storage system with at least one of a characteristic and a constraint with a data model;
means for manipulating data associated to the data model and enforces at least one of the constraint and the characteristic; and
means for invoking an API to manipulate data.
